(19) United States
(12) Patent Application Publication
(10) Pub. No.: US 2021/0399570 A1
(43) Pub. Date: Dec. 23, 2021

(54) Electric vehicle DC charging system using a voltage of 1250 volts output by a transformer

(71) Applicant: LUOLIANG XUE, Zhengzhou City (CN)

(72) Inventor: LUOLIANG XUE, Zhengzhou City (CN)

(21) Appl. No.: 16/935,419

(22) Filed: Jul. 22, 2020

(30) Foreign Application Priority Data
Jun. 18, 2020 (CN) 2020105612828

(51) Int. Cl. H02J 7/00; H02M 1/12; H02M 3/158; H02J 7/02

(52) U.S. Cl. CPC H02J 7/00711; H02M 1/126; B60L 53/16; H02J 7/02; H02M 3/1582

(57) ABSTRACT

Disclosed is an electric vehicle direct current (DC) charging system with a transformer capable of outputting a voltage of 1250 volts, including: a three-phase distribution transformer with an output end capable of outputting a line voltage of 1250 volts and a buck-type high-frequency pulse width modulation (PWM) rectifier-filter circuit; wherein the output end is connected with the buck-type high-frequency PWM rectifier-filter circuit; the buck-type high-frequency PWM rectifier-filter circuit is equipped with a charging controller, and the charging controller is configured for controlling the buck-type high-frequency PWM rectifier-filter circuit. The electric vehicle DC charging system with a transformer capable of outputting a voltage of 1250 volts according to the disclosure is a simplified charging system, thereby reducing cost and a power consumption of the electric vehicle DC charging system, and making charging more convenient.

### TECHNICAL FIELD

The disclosure relates to a rapid charging system for electric vehicles, and in particular to an electric vehicle direct current (DC) charging system with a transformer capable of outputting a voltage of 1250 volts.

### BACKGROUND

Nowadays, in order to meet the requirements of fast charging of batteries of electric vehicles, high-power direct current (DC) charging piles are required to be used. A power of a single switching power supply cannot be high enough due to the influence of the performance of electronic devices of the single switching power supply, so an existing high-power DC charging piles each are formed by multiple switching power supplies connected in parallel, and each switching power supply is powered by a transformer outputting a three-phase line voltage of a nominal value 220 volts or 380 volts. The switching power supply uses a boost rectifier to connect in series with a switching unit, and the switching power supply needs a high-frequency transformer, and a control device distributes a power for switching power supplies connected in parallel according to charging requirements of a storage battery to be charged. Further, for the above-mentioned charging pile, too many electronic devices are used, its wiring is complicated, its own device loss is high and the cost is high. In addition, the charging pile is a plug-and-charge but is controlled to supply power when a grid load is low.

### SUMMARY

In view of this, the disclosure provides a DC charging device small in size and large in capacity which is a simplified charging system and can capable of reducing cost and a power consumption of the electric vehicle DC charging system, and can be conveniently placed on an electric vehicle to form a vehicle-pile compatible fast-charging device to make charging more convenient.

In order to realize the above purposes of the disclosure, the following technical solutions are adopt.

An electric vehicle DC charging system with a transformer capable of outputting a voltage of 1250 volts is provided, which includes a three-phase distribution transformer with an output end capable of outputting a line voltage of 1250 volts and a buck-type high-frequency pulse width modulation (PWM) rectifier-filter circuit; wherein the output end is connected with the buck-type high-frequency PWM rectifier-filter circuit; the buck-type high-frequency PWM rectifier-filter circuit is equipped with a charging controller, and the charging controller is configured for controlling the buck-type high-frequency PWM rectifier-filter circuit.

The three-phase distribution transformer includes a primary high-voltage side and a secondary low-voltage side, the primary high-voltage side is configured for being configured for being connected to a public medium-voltage distribution network, and the secondary low-voltage side is capable of outputting the line voltage of 1250 volts.

The buck-type high-frequency PWM rectifier-filter circuit is a buck-type high-frequency PWM rectifier-filter.

The buck-type high-frequency PWM rectifier-filter circuit is for being arranged on a body of an electric vehicle to form a fast-charging device, the fast-charging system includes an on-vehicle charging socket, and the output end capable of outputting the line voltage of 1250 volts is disposed with a charging plug, and the charging plug is configured for being connected with the on-vehicle charging socket to charge the electric vehicle.

The buck-type high-frequency PWM rectifier-filter circuit includes capacitors and inductors, and the capacitors and the inductors are connected near the charging plug.

The charging controller is installed with a system controlled by peak and valley electricity prices of a power grid.

The three-phase distribution transformer comprises a secondary low-voltage side winding equipped with at least two charging plugs connected in parallel, and the electric vehicle DC charging system is configured for transmitting power onto the at least two charging plugs in a time-sharing and power-sharing manner according to a capacity of the three-phase distribution transformer.

The secondary low-voltage side winding further is equipped with at least two charging piles, and the electric vehicle DC charging system is configured for transmitting power onto the at least two charging pile in a time-sharing and power-sharing manner according to according to the capacity of the three-phase distribution transformer.

The disclosure has following beneficial effects: 1) a DC charging system for a battery of an electric vehicle is provided, which combines a distribution transformer outputting a voltage of 1250 volts with a buck-type high-frequency PWM rectifier-filter circuit, thereby avoiding the use of a switching power supply high-frequency transformer and reducing the number of used components; 2) an input voltage of the buck-type high-frequency PWM rectifier-filter circuit is high, which reduces a current of a loop of a switch tube and a diode, and there are few transistors connected in series, which reduces a power consumption of the system itself; 3) A capacity of a single system can be larger, and the capacity can be expanded through connecting multiple buck rectifier circuits in parallel; 4) since the system is small in size, it can be installed on an electric vehicle using a three-phase 1250-volt alternating current source for providing power supply; 5) the system of the disclosure has low cost, and can conveniently be installed with a controller for charging at low load of the power grid.

### BRIEF DESCRIPTION OF THE DRAWINGS

FIG. 1 is a circuit diagram of an electric vehicle DC charging system with a transformer capable of outputting a voltage of 1250 volts according to an embodiment; and

FIG. 2 is a circuit diagram of an electric vehicle DC charging system with a transformer capable of outputting a voltage of 1250 volts according to another embodiment.

### DETAILED DESCRIPTION OF EMBODIMENTS

The disclosure will be described in detail hereinafter with reference to the accompanying drawings and specific embodiments of the disclosure.

### First Embodiment

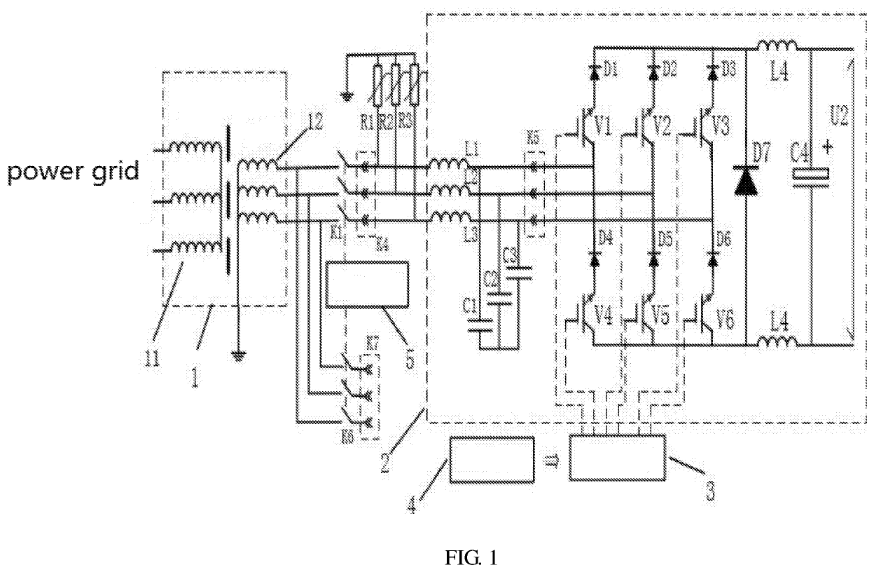

With reference to FIG. 1, an electric vehicle DC charging system with a transformer capable of outputting a voltage of 1250 volts includes a three-phase distribution transformer 1 with an output end capable of outputting a line voltage of 1250 volts and a buck-type high-frequency PWM rectifier-filter circuit 2. The output end is connected with the buck-type high-frequency PWM rectifier-filter circuit 2. The buck-type high-frequency PWM rectifier-filter circuit 2 is equipped with a charging controller 4, and the charging controller 4 is configured for controlling the buck-type high-frequency PWM rectifier-filter circuit 2.

The three-phase distribution transformer 1 includes a primary high-voltage side 11 and a secondary low-voltage side 12. The primary high-voltage side 11 is configured for being connected to a public medium-voltage distribution network, and the secondary low-voltage side 12 is capable of outputting the line voltage of 1250 volts (a phase voltage of 722 volts) and a neutral point is directly grounded.

The buck-type high-frequency PWM rectifier-filter circuit 2 is a buck-type high-frequency PWM rectifier-filter.

The three-phase distribution transformer includes the primary high-voltage side and the secondary low-voltage side, the primary high-voltage side is configured for being connected to the public medium-voltage distribution network, and the secondary low-voltage side is capable of outputting the line voltage of 1250 volts (the phase voltage of 722 volts), which transmits power onto the buck-type high-frequency PWM rectifier-filter. The voltage of 1250 volts is used to meet: 1. requirements for a nominal voltage of a battery; 2. requirements for a power factor control (PFC) requirements of a power grid; 3. requirements for voltage amplitude fluctuation of the power grid, for example, amplitude fluctuation of the voltage quality requirement of the national medium-voltage power grid is ±7%; 4. requirements of an end-of-charge voltage of the battery being higher than the nominal voltage of the battery. A voltage drop of a loop transistor is relatively small in a whole voltage loop and is not considered here. The voltage value of 1250 volts is calculated as follows:

An effective value of a phase voltage outputted by the three-phase distribution transformer is set as Uo, and a nominal voltage of a battery of a electric vehicle is set as U1.

In order to meet PFC requirements, Uo should be greater than or equal to u₀,

$${u}_{0} = \frac{{u}_{1}}{sin 60 ° \times \sqrt{2}}$$

\sqrt{2} is a coefficient for converting a maximum voltage value into an effective voltage value.

The above term is multiplied by 1.07 to meet requirements of 7% fluctuation of grid voltage.

$${u}_{0} = \frac{{u}_{1}}{sin 60 ° \times \sqrt{2}} \times 1.07$$

Because the ratio of the voltage drop of the loop transistor to that of the whole voltage loop is small, it will not be considered here. At present, the voltage of the battery of the electric vehicle is usually below 750 volts, so the voltage of the battery is calculated as 750 volts.

\sqrt{3}u₀=113.49 volts, and a voltage value of 1135 volts is taken as a value of the line voltage.

The end-of-charge voltage of the battery is about 10% higher than the nominal voltage of the battery, and end-of-charge voltages of some storage batteries are more than 10% higher than the nominal voltage. Since a charging current is small at a later stage during a charging period, requirements of the power grid for harmonics are met, a value 10% is considered here. Therefore, the line voltage outputted by the three-phase distribution transformer is greater than or equal to 1135×1.1=1248.5 volts, and a voltage value of 1250 volts is taken as the line voltage.

Based on the above calculation, when the line voltage outputted by the three-phase distribution transformer is 1250 volts, the three-phase distribution transformer can quickly charge all batteries with a nominal terminal voltage less than or equal to 750 volts.

The buck-type high-frequency PWM rectifier-filter circuit 2 includes an alternative current (AC) filter, a rectifier bridge, and a DC filter circuit, an output end of the buck-type high-frequency PWM rectifier-filter circuit is configured for being connected with a charging interface. The control of the buck-type high-frequency PWM rectifier-filter circuit 2 is performed according to requirements of the power factor of the power grid and battery charging strategies, a corresponding protection loop is added, and a PWM rectifier function is completed through isolated driving. electric vehicles are each installed with a battery circuit insulation detection system, and it is suggested that the installed system cannot detect the neutral point grounding of a secondary low-voltage side winding of the three-phase distribution transformer, and a group of secondary low-voltage side windings of the three-phase distribution transformer can be connected to multiple charging piles, thereby reducing the investment in construction of piles.

In the embodiment, the electric vehicle DC charging system includes an isolation driving circuit 3 and the charging controller 4. The charging controller 4 is configured for controlling the buck-type high-frequency PWM rectifier-filter circuit 2 through the isolation driving circuit 3.

Furthermore, a protection circuit 5 is disposed between the output end outputting the line voltage of 1250 volts of the three-phase distribution transformer 1 and the buck-type high-frequency PWM rectifier-filter circuit 2, and is configured to protect the buck-type high-frequency PWM rectifier-filter circuit 2.

The charging controller 4 is installed with a system controlled by peak and valley electricity prices of the power grid, and controls a charging process to be performed when an electricity price is cheap due to low load of the power grid, in case that parking time of the electric vehicle is allowed.

The three-phase distribution transformer includes a secondary low-voltage side winding equipped with at least two charging plugs connected in parallel. The electric vehicle DC charging system is configured for transmitting power onto the at least two charging plugs in a time-sharing and power-sharing manner according to a capacity of the three-phase distribution transformer. The electric vehicle is not required to be moved before or after charging, the capacity of the three-phase distribution transformer is saved and a utilization rate of the three-phase distribution transformer is improved. As shown in FIG. 1, charging plugs such as plug connectors K4 and K7 are shown.

The secondary low-voltage side winding further includes at least two charging piles, and the electric vehicle DC charging system is configured for transmitting power onto the at least two charging pile in a time-sharing and power-sharing manner according to according to the capacity of the three-phase distribution transformer. The electric vehicle is not required to be moved before or after charging, the capacity of the three-phase distribution transformer is saved and a utilization rate of the three-phase distribution transformer is improved.

The secondary low-voltage side winding of the three-phase distribution transformer is connected to the charging controller 4, which controls each charging pile and each 1250-volt power plug carried by the secondary low-voltage side winding. The charging controller 4 has functions of fault protection, power on/off, time-sharing control, power-sharing control, transformer overload prevention, communication with a power dispatching system and communication with vehicles. As a charging speed is fast, when the parking time of the electric vehicle is allowed, the charging controller 4 can control the electric vehicle to be charged during a low load period of the power grid. The electric vehicle DC charging system is configured for transmitting power onto each plug or charging pile in a time-sharing and power-sharing manner according to the capacity of the secondary low-voltage side winding. Multiple output ends are arranged for the secondary low-voltage side winding, and each output end sequentially transmits power on time, so that the electric vehicle is not required to be move from the parking space after charging, and the capacity of the three-phase distribution transformer is saved. In addition, the charging controller can be controlled using a power grid dispatching system, so that a charging load receives electricity at the time when a load of the power grid is low, thus achieving the purpose of balancing the load of the power grid.

The buck-type high-frequency PWM rectifier-filter circuit 2 according to the disclosure is small in size and convenient to be installed on the electric vehicle, the buck-type high-frequency PWM rectifier-filter circuit 2 can be made into a vehicle-pile integrated fast-charging device. A 1250 volt intelligent controlled plug is installed at a parking place, and an on-vehicle charging socket is installed on the electric vehicle, an on-vehicle charging device can be charged after the plug connector K4, as shown in FIG. 0.1. The on-vehicle charging controller is configured for controlling a linkage intelligent switch K1 to be turned on/off through communicating with a plug controller. The on-vehicle charging device charges a battery according to the requirements of the battery. The charging process can be set at a speed between a fast speed and a slow speed or set arbitrarily based on a charging strategy, to prolong the life of the battery. The charging controller controls the on-off power of the intelligent controlled plug outside the vehicle through a data line.

Preferably, the buck-type high-frequency PWM rectifier-filter circuit 2 includes capacitors and inductors, which are connected near the charging plug to reduce the number of on-vehicle devices. In the embodiment, in FIG. 1, piezoresistors R1, R2, R3, inductors L1, L2, L3, capacitors C1, C2, C3 are placed near the plug connector, and on-vehicle devices are set behind the rectifier bridge. K5 in FIG. 1 is a plug connector (K4 is not installed).

It is important that the on-vehicle charging controller or charging pile controller is installed with a software that is controlled by peak and valley electricity prices vary based on the load of the power grid, and controls a charging process to be performed when the electricity price is cheap, in case that parking time of the electric vehicle is allowed and, thus saving the vehicle cost and being beneficial to the economic operation of the power grid.

Referring to FIG. 1, in the embodiment, the DC charging pile includes the charging pile controller 4 and the buck-type high-frequency PWM rectifier-filter circuit 2.

The charging pile controller 4 has a modulation and protection loop, and an output signal end of the modulation and protection loop is connected with the gates of the buck-type high-frequency PWM rectifier switching tubes V1, V2, V3, V4, V5 and V6 through the isolation driving loop, and is configured to control the on/off of the switching tubes.

In the embodiment, the secondary low-voltage side 12 of the three-phase distribution transformer is a three-phase secondary low-voltage side winding outputting a line voltage of 1250 volts, multiple DC charging piles are provided, and the neutral point of the secondary low-voltage side winding is directly grounded. Through PWM modulation, an output current and an input power factor of the rectifier circuit are controlled, and the filter circuit makes a current ripple meet the charging requirements of the battery of the electric vehicle. The whole DC charging device charges the battery of the electric vehicle through an output terminal U2. It can also be extended, K4 and K7 in FIG. 1 are parallel plug connectors to achieve the purpose of time-sharing and power-sharing control.

### Second Embodiment

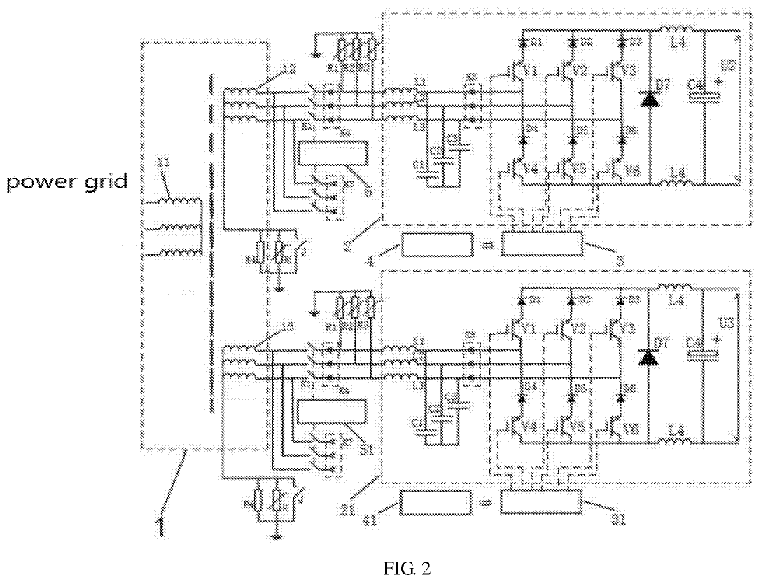

Referring to FIG. 2, the difference between the embodiment and the above-mentioned FIG. 1 is that the secondary low-voltage side of the three-phase distribution transformer 1 is provided with multiple three-phase secondary low-voltage side windings including secondary low-voltage side windings 12 and 13, and the number of the secondary low-voltage side windings can be increased as required and a neutral point of each winding is not directly grounded in order to meet electrical isolation requirements of each charging pile.

The number of DC charging piles is the same as that of the secondary low-voltage side windings. Each secondary low-voltage side winding has one charging pile, and the neutral point of the winding is grounded through a relay node (J in FIG. 2), a piezoresistor (R4 in FIG. 2) and a limiting resistor (R in FIG. 2) connected in parallel. The limiting resistor has a large resistance value to limit a potential drift of a low-voltage winding. The relay node is switched on when a charging pile operates and switched off when it does not operate. The piezoresistor prevents the neutral point from over-voltage. Other aspects are the same as the first embodiment.

In the embodiment, the secondary low-voltage side winding 13 further equipped with a charging controller 41, an isolation driving circuit 31 and a protection control circuit 51.

Referring to FIG. 1, a reference number 1 in FIG. 1 indicates a distribution transformer; reference numbers L1, L2 and L3 indicate filter inductors; reference numbers C1, C2 and C3 indicate energy storage capacitors; reference numbers V1, V2, V3, V4, V5 and V6 indicate switch tubes; reference numbers D1, D2, D3, D4, D5 and D6 indicate diodes; a reference number D7 indicates a freewheeling diode; a reference number L4 indicates an energy storage inductance; a reference number C4 indicates a filter capacitor; a reference number U2 indicates an output end of a charging pile; reference numbers R1, R2 and R3 indicate voltage limiting resistors; a reference number 11 indicates a transformer high-voltage winding, a reference number 12 indicates a transformer low-voltage winding; reference numbers K1 and K6 indicate linkage intelligent switches; reference numbers K4, K5 and K7 indicate plug connectors.

Referring to FIG. 2, reference numbers L1, L2 and L3 indicate filter inductors; reference numbers C1, C2 and C3 indicate energy storage capacitors; reference numbers V1, V2, V3, V4, V5 and V6 indicate switch tubes; reference numbers D1, D2, D3, D4, D5 and D6 indicate diodes; a reference number D7 indicate a freewheeling diode; a reference number L4 indicates an energy storage inductance; a reference number C4 indicate a filter capacitor; a reference number U2 indicates a charging pile output end, and a reference number U3 indicates a charging pile output end; reference numbers R1, R2, R3 and R indicate piezoresistors; a reference number R4 indicates a limiting resistance; a reference number J indicates a relay node; a reference number 1 indicates a distribution transformer, in which a reference number 11 indicates a high-voltage winding, a reference number 12 indicates a low-voltage winding and a reference number 13 indicates a low-voltage winding; a reference number K1 indicates a linkage intelligent switch; reference numbers K4, K5 and K7 indicates plug connectors.

The disclosure provides a high-power DC charging pile for charging electric vehicles. The charging pile adopts a three-phase distribution transformer outputting a line voltage of 1250 volts, and the output end of the three-phase distribution transformer is connected with a buck-type high-frequency PWM rectifier-filter circuit, and an output of buck-type high-frequency PWM rectifier-filter circuit provides power for the battery. With the disclosure, the structure of the charging pile is simplified and a power consumption of the device itself is reduced.

In addition, the buck-type high-frequency PWM rectifier-filter charging device is small in size, so it can be installed on a vehicle to form a fast-charging mode compatible with vehicle piles. The charging place is provided with a three-phase power supply plug wire with a line voltage of 1250 volts, and the vehicle can be charged quickly when connected a the power cord.

Because of the low cost of the device, it is convenient to install the charging timing controller, which can control the charging of the vehicle battery when the electricity price is low due to low load of the power grid, reduce charging cost and improve an economic operation level of the power grid.

The principle and implementation of the present disclosure are illustrated through specific examples, and the above embodiments are only used to facilitate understanding of the method and core idea of the present disclosure. According to the idea of the present disclosure, some changes can be performed on the specific implementation and application scope for the ordinary skilled in the art, and the output voltage of the three-phase distribution transformer can be a value around 1250 volts. Therefore, the value of 1250 volts in the specification should not be understood as limiting the disclosure.

What is claimed is:

1. An electric vehicle direct current (DC) charging system with a transformer capable of outputting a voltage of 1250 volts, comprising:
a three-phase distribution transformer with an output end capable of outputting a line voltage of 1250 volts and a buck-type high-frequency pulse width modulation (PWM) rectifier-filter circuit;
wherein the output end is connected with the buck-type high-frequency PWM rectifier-filter circuit; the buck-type high-frequency PWM rectifier-filter circuit is equipped with a charging controller, and the charging controller is configured for controlling the buck-type high-frequency PWM rectifier-filter circuit.

2. The electric vehicle DC charging system with a transformer capable of outputting a voltage of 1250 volts according to claim 1, wherein the three-phase distribution transformer comprises a primary high-voltage side and a secondary low-voltage side, the primary high-voltage side is configured for being configured for being connected to a public medium-voltage distribution network, and the secondary low-voltage side is capable of outputting the line voltage of 1250 volts.

3. The electric vehicle DC charging system with a transformer capable of outputting a voltage of 1250 volts according to claim 1, wherein the buck-type high-frequency PWM rectifier-filter circuit is for being arranged on a body of an electric vehicle to form a fast-charging device, the fast-charging device comprises an on-vehicle charging socket, and the output end capable of outputting the line voltage of 1250 volts is disposed with a charging plug, and the charging plug is configured for being connected with the on-vehicle charging socket to charge the electric vehicle.

4. The electric vehicle DC charging system with a transformer capable of outputting a voltage of 1250 volts according to claim 3, wherein the buck-type high-frequency PWM rectifier-filter circuit comprises capacitors and inductors, and the capacitors and the inductors are connected near the charging plug.

5. The electric vehicle DC charging system with a transformer capable of outputting a voltage of 1250 volts according to claim 1, wherein the charging controller is installed with a system controlled by peak and valley electricity prices of a power grid.

6. The electric vehicle DC charging system with a transformer capable of outputting a voltage of 1250 volts according to claim 1, wherein the three-phase distribution transformer comprises a secondary low-voltage side winding equipped with at least two charging plugs connected in parallel, and the electric vehicle DC charging system is configured for transmitting power onto the at least two charging plugs in a time-sharing and power-sharing manner according to a capacity of the three-phase distribution transformer.

7. The electric vehicle DC charging system with a transformer capable of outputting a voltage of 1250 volts according to claim 6, wherein the secondary low-voltage side winding further is equipped with at least two charging piles, and the electric vehicle DC charging system is configured for transmitting power onto the at least two charging pile in a time-sharing and power-sharing manner according to according to the capacity of the three-phase distribution transformer.
